(19) United States
(12) Patent Application Publication
(10) Pub. No.: US 2010/0083325 A1
(43) Pub. Date: Apr. 1, 2010

(54) Closed-Loop Community Influenced Broadcast Media Generation

(76) Inventor: Michael Broadbear, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/243,363

(22) Filed: Oct. 1, 2008

(51) Int. Cl. H04N 7/173

(52) U.S. Cl. 725/109

(57) ABSTRACT

A broadcast system comprises a broadcast device, a receiving device, and a content management system. The broadcast device is configured to transmit media over-the-air to a first user device. The receiving device is configured to receive over a network from a second user device a user input regarding the media. The content management system is configured to evaluate the user input and to select media for the broadcast device to broadcast based on the evaluation.

### FIELD

Embodiments of the present invention relate in general to the field of broadcast media.

### BACKGROUND

Radio has traditionally been a one-way stream of information sent from a station to its listeners. However, modern media such as those labeled “web 2.0” are increasingly allowing consumers to influence the content of the media “channels” they consume. There are several services available to increase user participation in the selection of media content.

One service provides a personal a media stream based on similar media to an initial song or artist to a user. The user may then influence the media stream with feedback on the media stream. This type of service may be found at www.pandora.com and www.last.fm. This type of service is not responsive to community generated broadcasting and is limited to users with devices capable of direct media feeds, such as netradios.

Another service provides a forum for user voting and ranking on the Internet for favorite media. With this service, users may vote for and/or select their favorite music and/or artists, whereby songs/artists with the most votes are promoted to the top of a community selected list. This type of service may be found at www.digg.com. A disadvantage with this type of service is a limited application to the Internet for both broadcasting media and receiving input thereof.

What is needed is community responsive broadcasting to an audience whereby users may receive the media over and provide feedback using multiple devices.

### SUMMARY

A broadcast system comprising a broadcast device, a receiving device, and a content management system is discussed herein. The broadcast device is configured to transmit media over-the-air to a first user device. The receiving device is configured to receive over a network from a second user device a user input regarding the media. The content management system is configured to evaluate the user input and to select media for the broadcast device to broadcast based on the evaluation.

### BRIEF DESCRIPTION OF THE DRAWINGS

FIG. 1 illustrates a community influenced broadcast system upon which embodiments of the present invention may be implemented.

FIG. 2 illustrates a device used to transmit information, in accordance with embodiments.

FIG. 3 is a flow chart of a method for broadcasting community influenced media, in accordance with embodiments.

### DESCRIPTION OF EMBODIMENTS

In the following description, numerous specific details are set forth in order to provide a thorough understanding. However, it will be recognized by one of ordinary skill in the art that embodiments may be practiced without these specific details. In other instances, well known methods, procedures, and components have not been described in detail as not to unnecessarily obscure aspects of the present invention.

### Overview

A broadcast media channel that broadcasts media based on user preferences and/or input from devices, such as mobile devices, is discussed. This permits a broadcast radio channel to capture user feedback and customize media. User responses are compiled and evaluated. The evaluation may be presented to broadcasters.

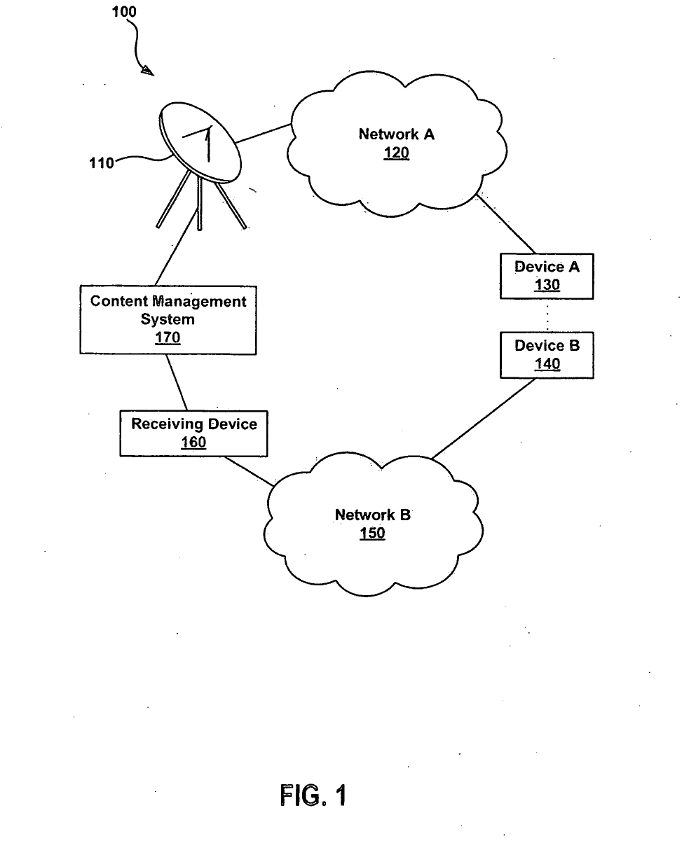

FIG. 1 illustrates a community influenced broadcast system 100 upon which embodiments of the present invention may be implemented. As illustrated, the broadcast system 100 comprises a broadcast device 110, a network A 120, a device A 130, a device B 140, a network B 150, a receiving device 160, and a content management system 170.

The broadcast device 110 is configured to transmit media over the network A 120 to the device A 130. The broadcast device 110 may be a tower dish, a satellite, and an emission building, or any other device that may broadcast media over-the-air. The media may be a song, an advertisement, news, a program, or any other media that may be broadcasted over a network. The network A 120 may be a radio broadcasting network, a television broadcasting network, or any other network that may be a means for media transmission over-the-air. In some embodiments, the network A 120 may be a plurality of networks wherein the media is broadcasted via the networks approximately simultaneously. In other embodiments, the media is broadcasted over the network A 120 and the Internet (not depicted).

The devices A 130 and B 140 are operated by a user who receives the media and provides input regarding the media. The device A 130 may be a radio, a visual radio, a mobile phone, a personal digital assistant, a computer, or any other device that may receive media broadcasted over-the-air. A visual radio may be any device using a visual radio service to receive over-the-air broadcast and digital network information. In some embodiments, the device B 140 may be the same device as the device A 130. In other embodiments, the device B 140 is a mobile phone, a personal digital assistant, a computer, a visual radio, or any other device that may transmit information over an analog or digital network.

In some embodiments, the broadcasting station may alert and/or notify a user when media a user provided input to is broadcasted. The station may send information to the device A 130 and/or device B 140 regarding the user's ranking of the media and/or a community ranking. The community ranking may be a combination of all rankings for the media or a subset of the total based on user provided information, such as an age group or geographical area.

The user input may be feedback regarding the media, such as personal preferences to a song. The user input may also be a ranking or any other comments that a user may wish to share, such as how a particular song makes the user feel in the morning. In various embodiments, the user input will be a response to a survey, a form, or other questionnaire that may be presented on the device A 130 via network A 120 and/or device B 140 via network B 150.

The network B 150 may be a telecommunication network, a computer network, or any network that the user of device B 140 may send input over a network. In some embodiments, the network B 150 may be used as a broadcasting network to broadcast the media approximately concurrently with media being broadcasted on the network A 120.

The receiving device 160 may be a computer server, a telecommunications server, of any other device that may receive input from the device B 140 via the network 150. The receiving device 160 relays the input to the content management system 170.

The content management system 170 is configured to evaluate the input and to select and/or recommend media for the broadcast device 110 to broadcast based on the evaluation. In some embodiments, the evaluation is based on a user supplied characterization. The user supplied characterization may include personalized information about the user such as age, gender, city of residence, occupation, commute time, school status, common times to receive media, and any other information that may be used to evaluate when and where to broadcast particular media.

The content management system 170 may be configured to disregard multiple inputs from the same device B 140 for the same media. This may prevent a user from casting several votes for the same media. For example, if a user attempts to promote the user's favorite song by voting for a particular song multiple times, the content management system 170 may use a filtering function based on an Internet Protocol address or some other means to limit the input to one response per particular media per broadcasting.

In some embodiments, multiple user responses are handled at the device B 140 by using unique device identification, such as a phone number associated with the device or other unique information. This approach may allow one vote per device. In other embodiments, this is performed via a user log-in requirement prior to entering feedback.

In some embodiments, the content management system 170 may report the evaluation to broadcasters of media. The report may list preferences for certain media and/or recommend a daily schedule for music. An advantage to play music preferred by a radio broadcaster's listeners is that the songs may reflect the listeners actual user likes and dislikes, and may be able to dynamically adapt based on real-time user preferences. In other embodiment, the content management system 170 is coupled to the broadcast device 110 and selects the media to broadcast in a real-time environment.

The evaluation may use the input, and any other information such as user identification, current network, current channel, time of rating, or any other previously stored information from this user such as past rankings, frequency of inputs received, and/or timestamp information. The evaluation may be based on frequencies of responses, weighted averages, algorithms, various other factors, for example user loyalty weighting, and/or other factors as discussed herein. The content management system 170 then ranks the current media. In some embodiments, the content management system 170 stores some or all the information collected for future evaluations.

In some embodiments, the user's input may be limited to a numeric ranking. In some embodiments, rankings are determined using timestamps. A timestamp of the input may be correlated to the time of the media broadcasted to pair user input with media. Play lists may be used to correlate inputs with media. In other embodiments, a real-time stream of events may be sent to an event collector service, whereby the service may be used to process matches of rankings with media.

Rankings may be provided to broadcast stations in various ways, such as a formatted report to the station, an Internet encoded page, for example xml, or other data formatted file that can be imported into an automated scheduling system. In some embodiments, a music director uses the formatted report to manually adjust the daily schedule, or an automated scheduling system references the user ratings to influence the schedule based on listener tastes. In various embodiments, a play list may be influenced by information supplied from devices configured to transmit user rankings of media.

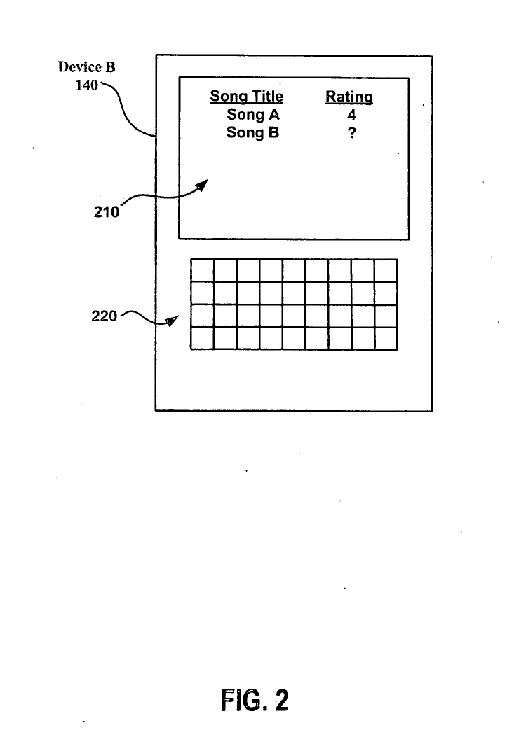

FIG. 2 illustrates the device B 140 used to transmit information, in accordance with embodiments. The device B 140 comprises a display 210 and an input mechanism 220. The display 210 may be a liquid crystal display or any other display that may show information to a user. The input mechanism 220 may be a full alphabet keypad, a keyboard, a numeric keypad, a phone pad, a wheel, or any other input mechanism that may be used to enter information.

In some embodiments, the display 210 presents a list of media, such as songs, currently being broadcasted. The user may then rank and/or provide comments regarding the song. In other embodiments, the device B 140 may be a mobile phone, where a user calls a number, listens to a recording, and ranks the song and/media, such as a ranking from 1 to 10. For example, a user may assign song A, a song currently being broadcasted, a rank of 4, and is may assign song B, a song in a queue to be broadcasting, a rank during or after listening to the song. In further embodiments, the device B 140 may be a WAP enabled phone, or any other web enabled device, such as a phone using i-mode, that communicates with the receiving device 160 via the Internet.

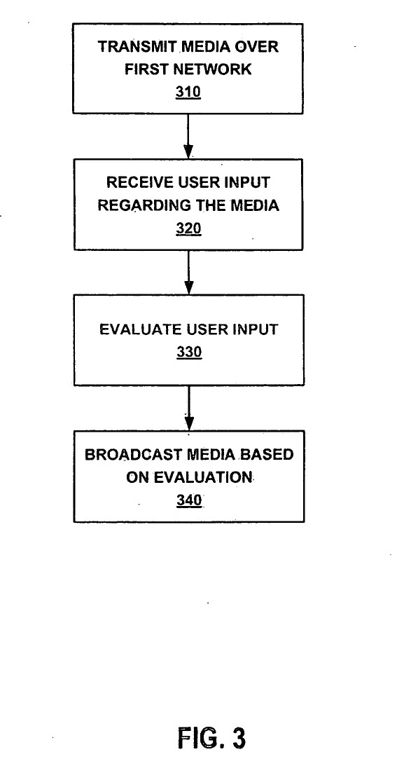

FIG. 3 is a flow chart of a method for broadcasting community influenced media, in accordance with embodiments. In step 310, a broadcasting station transmits media over a network, such as the network A 120. The media may be received by the device A 130. As the user of the device A 130 experiences the media or sometime thereafter, the user may relay an impression, a ranking, and/or any other feedback using the device A 130, if capable as discussed herein, or the device B 140.

In step 320, the receiving device 160 receives input from the user over the network B 150. The input and any other user information, such as log-in identification or network information, is relayed to the content management system 170. In step 330, the input is evaluated by the content management system 170, as herein discussed. In step 340, the media is broadcasted based on the evaluation, as herein discussed.

An advantage to incorporate direct user feedback into a broadcast station's playlist may provide a playlist that is responsive and preferred by a community. Thereby the broadcast station may influence listener retention, involvement, and user enjoyment. Additionally, the broadcast station may collect marketing information regarding users' preferences and tastes.

While the embodiments illustrated in steps 310-340 show specific sequences and quantity of steps, the present invention is suitable to alternative

Various alternatives, modifications, and equivalents may also be used. For example, a broadcast station may broadcast media selected by a user who won a contest. Therefore, the above description should not be taken as limiting the scope of the invention which is defined by the appended claims.

While the invention is described in conjunction with various embodiments, it is understood that they are not intended to limit the invention to these embodiments. On the contrary, the invention is intended to cover alternatives, modifications and equivalents, which may be included within the spirit and scope of the invention as defined by the appended claims.

What is claimed is:

1. A broadcasting system comprising:
a broadcast device configured to transmit media over-the-air to a first user device;
a receiving device configured to receive over a network from a second user device a user input regarding the media; and
a content management system configured to evaluate the user input and to select media for the broadcast device to broadcast based on the evaluation.

2. The broadcast system of claim 1, wherein the media is selected from the group consisting of a song, an advertisement, news, and a program.

3. The broadcast system of claim 1, wherein the broadcast device is selected from the group consisting of a tower dish, a satellite, and an emission building.

4. The broadcast system of claim 1, wherein the media is transmitted over a network selected from the group consisting of a radio broadcasting network, and a television broadcasting network.

5. The broadcast system of claim 1, wherein the media is transmitted over a plurality of networks.

6. The broadcast system of claim 1, wherein the network is selected from the group consisting of a telecommunications network, and a computer network.

7. The broadcast system of claim 1, wherein the first user device is selected from a group consisting of a radio, a visual radio, a mobile phone, a personal digital assistant, and a computer.

8. The broadcast system of claim 1, wherein the second user device is selected from a group consisting of a mobile phone, a personal digital assistant, a computer, a visual radio.

9. The broadcast system of claim 1, wherein the user input is feedback regarding the media.

10. The broadcast system of claim 1, wherein the user input is a ranking of the media.

11. The broadcast system of claim 1, wherein the evaluation is based on a user supplied characterization.

12. The broadcast system of claim 1, wherein the content management system is further configured to disregard multiple user inputs from the second device.

13. A method for broadcasting media comprising:
transmitting media over-the-air;
receiving over a network from a user device a user input regarding the media;
evaluating the user input; and
selecting media for to broadcast based on the evaluation.

14. The method of claim 13, wherein the broadcast device is selected from the group consisting of a tower dish, a satellite, and an emission building.

15. The method of claim 13, wherein the media is transmitted over a network selected from the group consisting of a radio broadcasting network, and a television broadcasting network.

16. The method of claim 13, wherein the network is selected from the group consisting of a telecommunications network, and a computer network.

17. The method of claim 13, wherein the user input is feedback regarding the media.

18. The method of claim 13, wherein the user input is a ranking of the media.

19. The method of claim 13, wherein the content management system is further configured to disregard multiple user inputs from the second device.

20. A system for broadcasting media comprising:
means for transmitting media over-the-air;
means for receiving over a network from a user device a user input regarding the media;
means for evaluating the user input; and
means for selecting media for to broadcast based on the evaluation.
